(19) United States
(12) Patent Application Publication
(10) Pub. No.: US 2025/0282691 A1
(43) Pub. Date: Sep. 11, 2025

(54) METHOD FOR SYNERGISTICALLY REDUCING NON-POINT SOURCE POLLUTION AND NITROUS OXIDE EMISSION IN VEGETABLE FIELD SOIL

(71) Applicant: INSTITUTE OF AGRICULTURAL RESOURCES AND REGIONAL PLANNING, CAAS, Beijing (CN)

(72) Inventors: Limei Zhai, Beijing (CN); Shufang Guo, Beijing (CN); Yinghua Yin, Beijing (CN); Hongyuan Wang, Beijing (CN); Hongbin Liu, Beijing (CN)

(21) Appl. No.: 19/052,773

(22) Filed: Feb. 13, 2025

(30) Foreign Application Priority Data
Mar. 6, 2024 (CN) 202410251092.4

(51) Int. Cl. C05F 3/00; A01C 21/00; C05F 5/00

(52) U.S. Cl. CPC C05F 3/00; C05F 5/002; A01C 21/00

(57) ABSTRACT

The present disclosure relates to a method for synergistically reducing non-point source pollution and nitrous oxide emission in vegetable field soil. The method provided by the present disclosure, by fully considering the carbon and nitrogen content, C/N ratio, and cellulose content of various exogenous carbon materials, reduce the application of nitrogen fertilizers based on the content of nitrate nitrogen in vegetable field soil while ensuring the nitrogen supply to vegetables, and increase the quantities of available carbon and the content of holocellulose by optimizing the combination and proportion of various exogenous carbon materials.

### CROSS REFERENCE TO RELATED APPLICATION

This patent application claims the benefit and priority of Chinese Patent Application No. 202410251092.4 filed with the China National Intellectual Property Administration on Mar. 6, 2024, the disclosure of which is incorporated by reference herein in its entirety as part of the present application.

### TECHNICAL FIELD

The present disclosure belongs to the field of agricultural environmental protection methods, and in particular relates to a method for synergistically reducing non-point source pollution and nitrous oxide emission in vegetable field soil.

### BACKGROUND

Currently, vegetable cultivation is dominated by smallholder farmers, where the prevalent use of “excessive irrigation and fertilization” has led to the outstanding problem of water and nitrogen overuse, which leads to a significant accumulation of nitrogen in the soil. The nitrate nitrogen accumulated in the soil is prone to lose through pathways such as runoff, leaching, and N₂O emission, resulting in soil salinization, soil acidification, greenhouse effect, surface water eutrophication, and nitrate pollution in groundwater. Consequently, regulation of the production and accumulation of nitrate nitrogen in vegetable field soil is one of the pivotal strategies to reduce nitrogen loss. The process of reducing the concentration of nitrate nitrogen in the soil by increasing the assimilation rate of nitrate nitrogen in vegetable field soil has unique advantages, as it facilitates the conversion of nitrate nitrogen into microbial biomass nitrogen for short-term storage, which can subsequently undergo remineralization, offering nitrogen conservation and being environmentally friendly.

The assimilation of nitrate nitrogen serves as an important mean to reduce the concentration of nitrate nitrogen in the soil, alleviate the accumulation of nitrate nitrogen, and limit the migration of nitrate nitrogen to water through leaching or runoff. The enhanced assimilation of nitrate nitrogen by soil microorganisms will form competition between soil heterotrophic microorganisms and denitrifying microorganisms for available carbon, ultimately reducing N₂O emissions. However, organic fertilizers, such as rapeseed cake and chicken manure, are commonly used in vegetable-growing soils, which have no significant effect on the assimilation rate of nitrate nitrogen in the soil. This is not conducive to the assimilation of nitrate nitrogen in vegetable field soil, and the accumulated nitrate nitrogen is easily leached into groundwater and lost through N₂O emission.

### SUMMARY

To address the problems mentioned above, the present disclosure provides a method for synergistically reducing non-point source pollution and nitrous oxide emission in vegetable field soil. The method provided by the present disclosure increases the quantity of available carbon by optimizing the combination and proportion of various exogenous carbon materials based on the content of nitrate nitrogen in vegetable field soils, thereby reducing the use of nitrogen fertilizers, improving the assimilation of nitrate nitrogen in vegetable field soils, and reducing N₂O emission of the soil, ultimately achieving the synergetic reduction and regulation of the non-point source pollution and N₂O emission of the vegetable field soil. The method has the characteristics of clear technology, simplicity, convenience, and easy to implement.

In order to achieve the objective described above, the present disclosure provides the following technical solutions.

The present disclosure provides a method for synergistically reducing non-point source pollution and nitrous oxide emission in vegetable field soil, including the following step:
applying a base fertilizer and an exogenous organic carbon mixture to the soil; wherein the base fertilizer includes a chemical fertilizer and an animal manure; the exogenous organic carbon mixture includes an agricultural waste and/or a forestry waste; the mass ratio of the exogenous organic carbon mixture to the animal manure is in the range of 0.8:1-1.25:1;
the exogenous organic carbon mixture has a carbon-to-nitrogen ratio (C/N ratio) of more than 25;
when the carbon-to-nitrogen ratio in the soil is less than 7, selecting the agricultural wastes and/or the forestry wastes with a holocellulose mass percentage content ranging from 40%-50% and a holocellulose mass percentage content of more than 50% to compound to obtain the exogenous organic carbon mixture; and
when the carbon-to-nitrogen ratio in the soil is equal to or more than 7, selecting the agricultural wastes and/or the forestry wastes with a holocellulose mass percentage content of less than 40% and a holocellulose mass percentage content ranging from 40%-50% to compound to obtain the exogenous organic carbon mixture.

In some embodiments, the mass ratio of the nitrogen element in the chemical fertilizer to the nitrogen element in the animal manure is in the range of 1:0.8-1:1.

In some embodiments, the animal manure includes one or more selected from the group consisting of a chicken manure, a pig manure, and a cow manure.

In some embodiments, the agricultural waste and/or the forestry waste includes one or more selected from the group consisting of crop straw, rice husk, rice bran, corn leaves, sawdust, pine needles, fallen leaves, and sugarcane bagasse.

In some embodiments, the crop straw includes one or more selected from the group consisting of corn straw, wheat straw, and rice straw.

In some embodiments, the soil includes the soil used for growing vegetables.

### Beneficial Effects

By fully considering the carbon and nitrogen content, C/N ratio, and cellulose content of various exogenous carbon materials, the method provided by the present disclosure increases the quantity of available carbon and the content of holocellulose by optimizing the combination and proportion of various exogenous carbon materials based on the content of nitrate nitrogen in vegetable field soil while ensuring the nitrogen supply to vegetables, thereby reducing the use of nitrogen fertilizers, improving the assimilation of nitrate nitrogen in vegetable field soil, and reducing N₂O emission of the soil, ultimately achieving the synergetic reduction and regulation of the non-point source pollution and N₂O emission of the vegetable field soil. The method has the characteristics of clear technology, simplicity, convenience, and easy to implement.

### BRIEF DESCRIPTION OF THE DRAWINGS

To describe the technical solutions in the examples of the present disclosure or in the conventional technology more clearly, the accompanying drawings required for the examples will be briefly described below.

FIG. 1 shows the results of the immobilization rate of NO₃⁻—N in the soil for conventional fertilizers+chicken manure and fertilizers+chicken manure+organic materials;

FIG. 2 shows the relationship between the immobilization rate of NO₃⁻—N in vegetable field soil and the content of holocellulose in the organic materials; and

FIGS. 3A-3C show the reduction of NO₃⁻—N content, NO₃⁻—N leaching, and N₂O emission amount with the addition of various organic materials to vegetable field soil.

### DETAILED DESCRIPTION OF THE EMBODIMENTS

The present disclosure provides a method for synergistically reducing non-point source pollution and nitrous oxide emission in vegetable field soil, including the following step:
a base fertilizer and an exogenous organic carbon mixture are applied to the soil; wherein the base fertilizer includes a chemical fertilizer and an animal manure; the exogenous organic carbon mixture includes an agricultural waste and/or a forestry waste; the mass ratio of the exogenous organic carbon mixture to the animal manure is in the range of 0.8:1-1.25:1;
the exogenous organic carbon mixture has a carbon-to-nitrogen ratio of more than 25;
when the carbon-to-nitrogen ratio in the soil is less than 7, the agricultural wastes and/or the forestry wastes with a holocellulose mass percentage content ranging from 40%-50% and a holocellulose mass percentage content of more than 50% are selected and compounded to obtain the exogenous organic carbon mixture; and
when the carbon-to-nitrogen ratio in the soil is equal to or more than 7, the agricultural wastes and/or the forestry wastes with a holocellulose mass percentage content of less than 40% and a holocellulose mass percentage content ranging from 40%-50% are selected and compounded to obtain the exogenous organic carbon mixture.

In the present disclosure, the mass ratio of the nitrogen element in the chemical fertilizer to the nitrogen element in the animal manure is in the range of 1:0.8-1:1; the animal manure preferably includes one or more selected from the group consisting of a chicken manure, a pig manure, and a cow manure; the agricultural waste and/or the forestry waste preferably includes one or more selected from the group consisting of crop straw, rice husk, rice bran, corn leaves, sawdust, pine needles, fallen leaves, and sugarcane bagasse; the crop straw preferably includes one or more selected from the group consisting of corn straw, wheat straw, and rice straw; and the soil includes the soil used for growing vegetables.

In the present disclosure, keywords such as “organic fertilizer,” “organic material,” “exogenous carbon,” “carbon,” “nitrogen,” “C/N ratio” and “cellulose” are searched preferably in databases such as Web of Science and CNKI, the C, N or C/N ratio and the proportion of cellulose of various exogenous carbon materials are obtained through screening. The results are shown in Table 1.

TABLE 1
Content of carbon, nitrogen and holocellulose
of common exogenous carbon materials

| | Organic | Total | | Holocellulose |
|---|---|---|---|---|
| Type | carbon (%) | nitrogen (%) | C/N | (%) |
| Rice husk | 40.6 | 0.51 | 79.0 | 41.5 |
| Sawdust | 52.7 | 0.13 | 403 | 52.4 |
| Rice bran | 44.2 | 0.78 | 57.1 | 39.8 |
| Corn leaves | 44.6 | 1.32 | 33.9 | 46.0 |
| Corn straw | 48.9 | 1.10 | 44.0 | 49.6 |
| Wheat straw | 45.0 | 0.30 | 150 | 43.7 |

Based on literature data or actually measured carbon and nitrogen content of organic materials, the C/N ratio of an organic material compounded by multiple materials is calculated as follows:

$$C / N = \frac{{\sum }_{k = 1}^{n} ( {W}_{k} \times {P}_{C , k} )}{{\sum }_{k = 1}^{n} ( {W}_{k} \times {P}_{N , k} )} . \qquad Formula I$$

In Formula I, C/N represents the C/N ratio of an organic material added with n types of exogenous carbon materials, Wₖ represents the mass (g) of the kth exogenous carbon material, P_{C,k} and P_{N,k} represent the C content and the N content (%) of the kth exogenous carbon material, respectively, and n represents the number of types of the exogenous carbon materials.

Based on literature data or actually measured holocellulose content of organic materials, the holocellulose content of an organic material compounded by multiple materials is calculated as follows:

$$H = \frac{{\sum }_{k = 1}^{n} ( {W}_{k} \times {H}_{k} )}{{\sum }_{k = 1}^{n} ( {W}_{k} )} . \qquad Formula II$$

In Formula II, H represents the holocellulose content (%) of an organic material added with n types of exogenous carbon materials, Wₖ represents the mass (g) of the kth exogenous carbon material, Hₖ represents the holocellulose content (%) of the kth exogenous carbon material, and n represents the number of types of the exogenous carbon materials.

The assimilation rate of nitrate nitrogen in dryland soil with an exogenous carbon input increases with the increase of the input amount of a carbon source with a high C/N ratio and the content of holocellulose. Suitable exogenous carbon materials are selected according to the nitrate content in vegetable field soil, and the carbon-to-nitrogen ratio of a mixed material with different gradations is determined. For complex carbon sources such as straw, the assimilation of nitrate nitrogen can only be improved when having a C/N ratio exceeding 25, and the C/N of exogenous carbon can be classified into four levels: [25-50), [50-80), [80-110], and >110. When the C/N ratio of organic materials is similar, the assimilation rate of nitrate nitrogen in the soil is high when the content of holocellulose is high, and the content of holocellulose is classified into three grades: <40%, 40%-50%, and >50%.

In the present disclosure, the mass ratio of the exogenous organic carbon mixture to the animal manure is 0.8:1-1.25:1. This ratio is beneficial for adjusting moisture content and carbon-to-nitrogen ratio, increasing the content of organic matter, and enhancing the permeability of soil. If the ratio is too low or too high, it is not conducive to microbial activity.

Currently, the exogenous carbon addition in vegetable fields is mostly the addition of single materials. Compared to other crops, vegetable field soil with high moisture and high fertilizer are prone to nitrate nitrogen accumulation in soil, which increases the risk of non-point source pollution and N₂O emissions. In the present disclosure, the assimilation ability of nitrate nitrogen in the soil is improved by considering the proportion of various exogenous carbon materials, and the nitrate nitrogen in the soil is converted into microbial biomass nitrogen for short-term storage and then remineralization. This helps preserve nitrogen in the soil and reduces the risk of nitrogen loss to the environment. In the present disclosure, based on the nitrate nitrogen content in vegetable field soil and the C/N ratio and cellulose content of main exogenous carbon materials, the application amount of nitrogen fertilizers is reduced through the combination and proportional formulation of various exogenous carbon materials, the assimilation of nitrate nitrogen in the soil is improved, and the emission of N₂O is reduced. This method not only achieves the objective of rational fertilization in vegetable fields and reducing the accumulation of nitrate nitrogen in the soil, but also provides technical support for preventing and regulating non-point source pollution in vegetable field ecosystems and synergistically reducing greenhouse gas emissions.

By optimizing the combination and proportion of various exogenous carbon materials to increase the quantity of available carbon and the content of holocellulose, the technical scheme of the present disclosure reduces the use amount of nitrogen fertilizers while ensuring the nitrogen supply to vegetables. An increased C/N ratio of organic materials will reduce the cumulative emission of N₂O. For example, the addition of straws with a high C/N ratio will increase the demand for nitrogen due to the assimilation of inorganic nitrogen in the soil by soil microorganisms, thereby reducing N₂O emissions. Conversely, straws with a low C/N ratio decompose faster, providing substrates for nitrification and denitrification reactions and producing more N₂O emissions.

To further illustrate the present disclosure, the method for synergistically reducing non-point source pollution and nitrous oxide emission in vegetable field soil provided by the present disclosure will be described in detail below in conjunction with the accompanying drawings and examples. However, this should not be construed as limiting the scope of protection of the present disclosure.

### Example 1

Tomatoes were planted in greenhouses in the North China Plain, with the C/N ratio of 6.5 of the 0-30 cm soil of the initial tillage layer. Conventional treatment: the chicken manure, as a base fertilizer, was air-dried chicken manure, and the application rate was the usual amount used by farmers, with 200 kgN/hm² applied every season; and the application rate of chemical fertilizers was 230 kgN/hm² per season, a usual amount for farmers. Urea was used as a nitrogen fertilizer, with an amount of 230 kgN/hm² per season, triple superphosphate was used as a phosphatic fertilizer, with an application amount of 90 kgP₂O₅/hm² per season, and potassium sulfate was used as a potassium fertilizer, with an application amount of 650 kgK₂O/hm² per season. Organic materials included wheat straw with 45% C and 0.4% N, corn straw with 37.4% C and 1.05% N, rice husk with 38.5% C and 0.50% N, and corn leaves with 45.0% C and 1.15% N. The mixture was added at an amount of 1.1 times the weight of chicken manure. The material with a C/N ratio of 30-40 was a mixture of 10% corn leaves and 90% corn straw (with 49.2% holocellulose content), the material with a C/N ratio of 70-80 was a mixture of 95% rice husk and 5% wheat straw (with 41.6% holocellulose content), and the material with a C/N ratio more than 110 was a mixture of 95% wheat straw and 5% rice husk (with 43.6% holocellulose content). Static chamber-gas chromatography was used to measure the N₂O emission flux of the soil during the entire growing season. The measurement was carried out every 1-2 days for the first week after fertilization, and then once a week thereafter. The soil samples were collected after crop harvest to measure the content of NO₃⁻—N in the soil. The immobilization rate of NO₃⁻—N in the soil was calculated using indoor cultivation, isotope labeling, and mathematical modeling methods. The leaching amount of NO₃⁻—N was measured by using the leaching pool method.

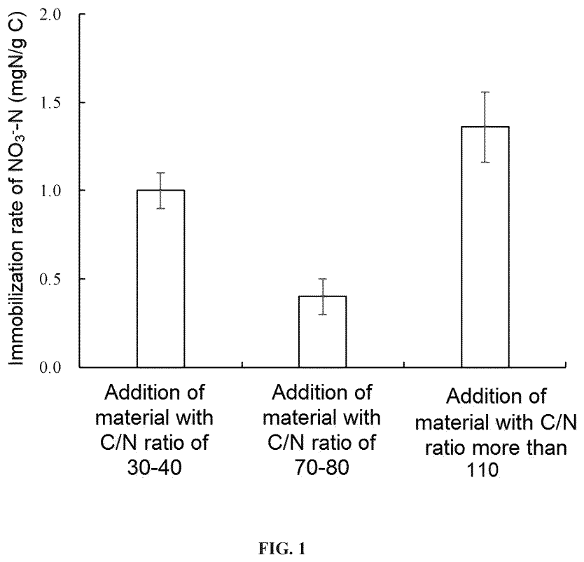

As can be seen from FIG. 1, after the implementation of the method, the immobilization rate of NO₃⁻—N in the soil after adding an organic material with a C/N ratio of 30-40 was 1 mgN/gC, the immobilization rate of NO₃⁻—N in the soil after adding an organic material with a C/N ratio of 70-80 was 0.4 mgN/gC, and the immobilization rate of NO₃⁻—N in the soil after adding an organic material with a C/N ratio more than 110 was 1.36 mgN/gC, compared to the treatment of a conventional fertilizer+chicken manure.

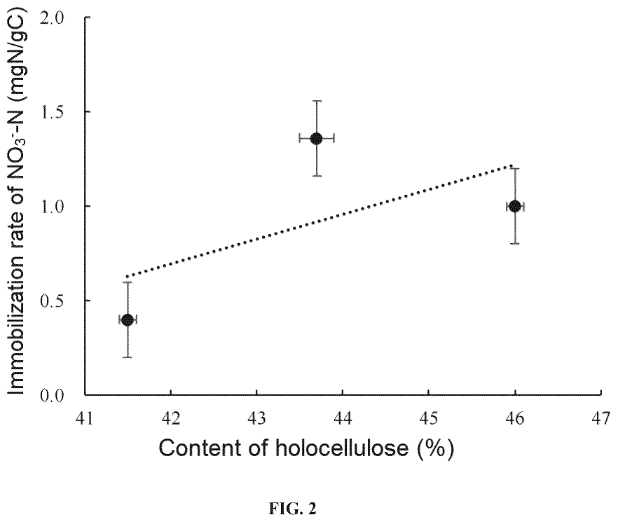

FIG. 2 showed that, the immobilization rate of NO₃⁻—N in the soil increased with the increase of the cellulose content in the organic material.

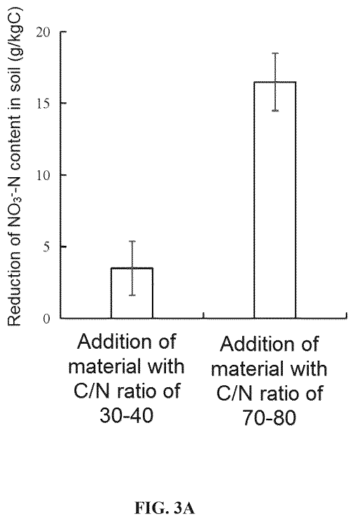

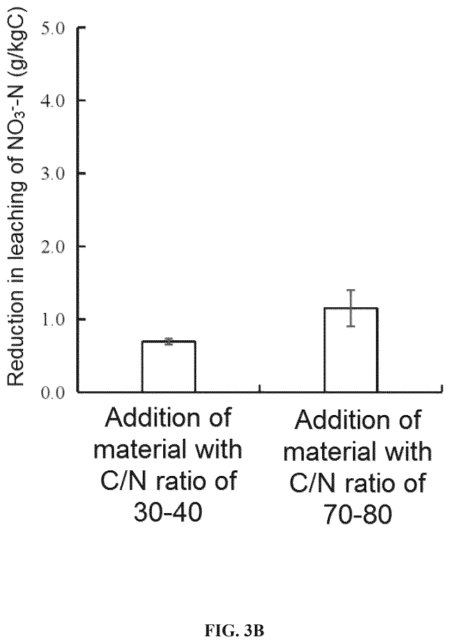

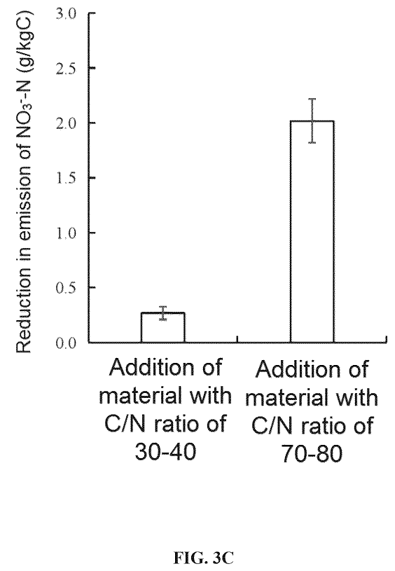

From FIGS. 3A-3C, it can be seen that compared to conventional treatment, the content of NO₃⁻—N in the soil was reduced by 3.51 g/kgC with the addition of the organic material with a C/N ratio of 30-40, and the content of NO₃⁻—N in the soil was reduced by 16.5 g/kgC with the addition of the organic material with a C/N ratio of 70-80. The leaching amount of NO₃⁻—N in the vegetable field was reduced by 0.69 g/kgC with the addition of the organic material with a C/N ratio of 30-40, and the leaching amount of NO₃⁻—N in the vegetable field was reduced by 1.15 g/kgC with the addition of the organic material with a C/N ratio of 70-80. The emission amount of N₂O could be reduced by 0.27 g/kgC with the addition of the organic material with a C/N ratio of 30-40, and the emission amount of N₂O could be reduced by 2.02 g/kgC with the addition of the organic material with a C/N ratio of 78-80.

Although the examples described above have provided a detailed description of the present disclosure, they are only a part of the examples of the present disclosure, not all of them. All other examples that can be obtained according to the examples of the present disclosure without involving any inventive steps shall fall within the scope of protection of the present disclosure.

What is claimed is:

1. A method for synergistically reducing non-point source pollution and nitrous oxide emission in vegetable field soil, comprising the following step:
applying a base fertilizer and an exogenous organic carbon mixture to the soil; wherein the base fertilizer comprises a chemical fertilizer and an animal manure; the exogenous organic carbon mixture comprises an agricultural waste and/or a forestry waste; and the mass ratio of the exogenous organic carbon mixture to the animal manure is in the range of 0.8:1-1.25:1;
the exogenous organic carbon mixture has a carbon-to-nitrogen ratio of more than 25;
when the carbon-to-nitrogen ratio in the soil is less than 7, selecting the agricultural wastes and/or the forestry wastes with a holocellulose mass percentage content ranging from 40%-50% and a holocellulose mass percentage content of more than 50% to compound to obtain the exogenous organic carbon mixture; and
when the carbon-to-nitrogen ratio in the soil is equal to or more than 7, selecting the agricultural wastes and/or the forestry wastes with a holocellulose mass percentage content of less than 40% and a holocellulose mass percentage content ranging from 40%-50% to compound to obtain the exogenous organic carbon mixture.

2. The method according to claim 1, wherein the mass ratio of the nitrogen element in the chemical fertilizer to the nitrogen element in the animal manure is in the range of 1:0.8-1:1.

3. The method according to claim 1, wherein the animal manure comprises one or more selected from the group consisting of a chicken manure, a pig manure, and a cow manure.

4. The method according to claim 1, wherein the agricultural waste and/or the forestry waste comprises one or more selected from the group consisting of crop straw, rice husk, rice bran, corn leaves, sawdust, pine needles, fallen leaves, and sugarcane bagasse.

5. The method according to claim 4, wherein the crop straw comprises one or more selected from the group consisting of corn straw, wheat straw, and rice straw.

6. The method according to claim 1, wherein the soil comprises the soil used for growing vegetables.

7. The method according to claim 2, wherein the animal manure comprises one or more selected from the group consisting of a chicken manure, a pig manure, and a cow manure.
